(19) United States
(12) Patent Application Publication
(10) Pub. No.: US 2024/0013261 A1
(43) Pub. Date: Jan. 11, 2024

(54) CONTENT CONTROL DEVICE, PROGRAM, AND CONTENT CONTROL METHOD

(71) Applicant: Sharp NEC Display Solutions, Ltd., Tokyo (JP)

(72) Inventor: Akira UCHIYAMA, Tokyo (JP)

(21) Appl. No.: 18/239,007

(22) Filed: Aug. 28, 2023

Related U.S. Application Data
(63) Continuation of application No. PCT/JP2021/011604, filed on Mar. 22, 2021.

(51) Int. Cl. G06Q 30/0272; G06Q 10/087

(52) U.S. Cl. CPC G06Q 30/0272; G06Q 10/087

(57) ABSTRACT

A content control device includes a reception unit configured to receive sales data transmitted from a terminal of a store, a first calculation unit configured to obtain a sales amount, which is a sum of prices for first products sold, as target products, on the basis of the received sales data, and to obtain an inventory quantity of the first products, a determination unit configured to determine a magnitude relationship between at least one of the sales amount and the inventory quantity and a reference value, a control unit configured to determine a display level for displaying contents related to the first products and contents related to second products that is different from the first products in a display region according to a result of the determination, and a second calculation unit configured to output instructions to display the contents related to the first products and the contents related to the second products in a display region according to a display level determined by the control unit.

### TECHNICAL FIELD

The present invention relates to a content control device, a program, and a content control method.

### BACKGROUND ART

In a retail store that sells products to consumers, sales promotion activities are widely performed with advertisements that post advertisements for products, displayed in the store for sale, inside and outside the store to lead to consumers' purchasing behavior.

For example, in a retail store such as an apparel shop, sales promotions using digital signage have been implemented in recent years.

The main purpose of the sales promotions in digital signage is to announce and advertise products intended to attract customers or to strengthen sales. For example, there are cases in which a plan for attracting customers is made by posting advertisements for products such as sale items.

In addition, a display system that adjusts a display time of advertisement contents is provided (Patent Document 1). In this display system, for example, in supermarkets or the like, it is possible to promote sales by displaying an advertisement before an expiry date is reached and to reduce the amount of waste of food items to be sold. Furthermore, a price of a food item must be lowered when the expiry date is reached, so that it is possible to promote sales by displaying an advertisement for such products before the price is lowered in this display system. This display system extracts a food item with a large amount of inventory among food items whose expiry dates are approaching, displays an advertisement for products such as the food item, and increases the display time.

### CITATION LIST

### Patent Document

### [Patent Document 1]

Japanese Unexamined Patent Application, First Publication No. 2010-97439

### SUMMARY OF INVENTION

### Technical Problem

However, when an advertisement for products such as sale items and the like is made, it is possible to effectively attract customers. However, there is a problem that consumers' purchases are concentrated on the sale items selected for sales promotion, and other products are not purchased.

In addition, when the display time of the product advertisement is adjusted in consideration of an amount of inventory of food items whose expiry dates are being reached, it is possible to promote sales of products whose expiry dates are being reached, but it is not something that can attract customers.

An object of the present invention is to provide a content control device, a program, and a content control method that can dynamically perform sales promotion management according to a customer-attracting situation.

### Solution to Problem

According to one aspect of the present invention, a content control device includes a reception unit configured to receive sales data transmitted from a terminal of a store, a first calculation unit configured to obtain a sales amount, which is a sum of prices for first products sold, which is a target product, on the basis of the received sales data, and to obtain an inventory quantity of the first product, a determination unit configured to determine a magnitude relationship between at least one of the sales amount and the inventory quantity and a reference value, a control unit configured to determine a display level for displaying contents related to the first product and contents related to second products that is different from the first product in a display region according to a result of the determination, and a second calculation unit configured to output instructions to display the contents related to the first product and the contents related to the second product in a display region according to a display level determined by the control unit.

In addition, according to another aspect of the present invention, a program causes a computer to execute receiving sales data transmitted from a terminal of a store, obtaining a sales amount, which is a sum of prices for first products sold, which is a target product, on the basis of the received sales data, and obtaining an inventory quantity of the first product, determining a magnitude relationship between at least one of the sales amount and the inventory quantity and a reference value, determining a display level for displaying contents related to the first products and contents related to second products that is different from the first products in a display region according to a result of the determination, and outputting instructions to display the contents related to the first products and the contents related to the second products in a display region according to a determined display level.

According to still another aspect of the present invention, a content control method that is executed by a computer includes receiving sales data transmitted from a terminal of a store, obtaining a sales amount, which is a sum of prices for first products sold, as target products, on the basis of the received sales data, and obtaining an inventory quantity of the first products, determining a magnitude relationship between at least one of the sales amount and the inventory quantity and a reference value, determining a display level for displaying contents related to the first products and contents related to second products that is different from the first products in a display region according to a result of the determination, and outputting instructions to display the contents related to the first products and the contents related to the second products in a display region according to a determined display level.

### Advantageous Effects of Invention

According to the present invention, sales promotion management can be dynamically performed according to a customer-attracting situation.

### BRIEF DESCRIPTION OF DRAWINGS

FIG. 1 is a schematic block diagram which shows a configuration of a display system 1 according to one embodiment of the present invention.

FIG. 2 is a functional block diagram which describes a function of a POS register 21.

FIG. 3 is a functional block diagram which describes a function of a POS server 32.

FIG. 4 is a functional block diagram which describes a function of a content server 33.

FIG. 5 is a diagram which shows an example of product management data stored in products management database 3231 of the POS server 32.

FIG. 6 is a sequence diagram which describes an operation of the display system 1.

FIG. 7 is a flowchart which describes an operation of the POS server 32.

FIG. 8 is a diagram which shows an example of aggregate data.

FIG. 9 is a diagram which describes a case in which content is displayed on a display device 24 according to a display time.

FIG. 10 is a diagram which describes the case in which content is displayed on the display device 24 according to a display time.

FIG. 11 is a diagram which describes a case in which content is displayed on the display device 24 according to a display area.

FIG. 12 is a diagram which describes a case in which content is displayed on the display device 24 according to a display area.

FIG. 13 is a diagram which shows an example of a case in which a plurality of display devices are installed.

FIG. 14 is a diagram which shows an example of the case in which a plurality of display devices are installed.

FIG. 15 is a schematic block diagram which describes a configuration of a content control device 42.

### DESCRIPTION OF EMBODIMENTS

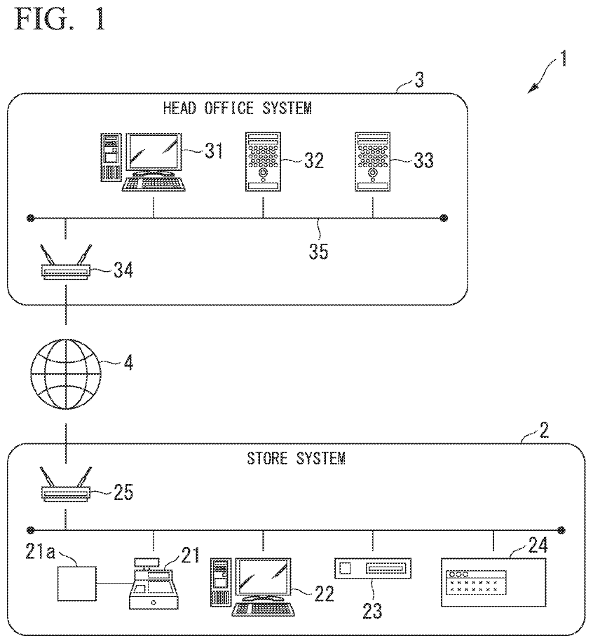

A display system according to one embodiment of the present invention will be described with reference to the drawings. FIG. 1 is a schematic block diagram which shows a configuration of a display system 1 according to one embodiment of the present invention.

The display system 1 is connected to a store system 2 and a head office system 3 via a network 4 in a communicative manner. The network 4 is, for example, the Internet. The store system 2 is provided in each store when there are a plurality of stores. The head office system 3 is connected to the store system 2 provided in a store to be managed, and is provided at a base functioning as a head office. The store may be a chain store and the head office may manage each chain store. In addition, when there is one store to be managed, the store system 2 and the head office system 3 can be set as one system and installed in the one store.

In the store system 2, a POS register 21, a store client 22, a media player 23, a display device 24, and a router 25 are connected to each other via a local network 26 in a communicative manner.

The POS register 21 is connected to a scanner 21a. The scanner 21a may be, for example, a barcode reader or an IC tag reader. The scanner 21a may be connected to an outside of the POS register 21 or may be provided inside a housing of the POS register 21.

The scanner 21a reads a machine reading code of tags attached to products. This machine reading code is read from products tag of products to be accounted for when the product is sold. Product tag has product identification code that can identify products. For example, a machine reading code representing product identification code is printed on product tag. The machine reading code is, for example, a barcode or a two-dimensional barcode. In addition, the product tag may be an IC tag in which the machine reading code is stored. The scanner 21a optically reads the product identification code from the product tag on which the product identification code is printed. When the scanner 21a reads the product identification code from the IC tag in which the product identification code is stored, it reads the product identification code stored in the IC tag by performing non-contact communication with the IC tag. The scanner 21a outputs the read product identification code to the POS register 21.

The POS register 21 acquires product identification code read by the scanner 21a from the scanner 21a and transmits the acquired product identification code to the POS server 32. The POS register 21 transmits the product identification code to the head office system 3 via the router 25, the network 4, and a router 34 when the POS server 32 is connected to an outside of the store system 2.

The store client 22 is, for example, a computer, and an input device such as a keyboard or a mouse and a display device are connected. The store client 22 receives an operation input from a user through the input device, and performs instructions and setting for each device in the store system 2 according to content of the operation input.

A media player 23 is connected to the display device 24 via a video cable. The media player 23 receives content data from a content server 33. The media player 23 decodes the content data, executes reproduction processing thereon, and outputs a video signal to the display device 24.

At least one display device 24 is installed inside or outside the store to display the video signal. For example, at least one of a liquid crystal display device and a projector can be used as the display device 24. The display device 24 and the video signal are, for example, a video and a sound corresponding to the content data supplied from the content server 33. The display device 24 functions as a digital signage by outputting the content data.

The display device 24 receives the video signal output from the media player 23 and displays the video signal on a display screen. The display screen is a liquid crystal panel when the display device 24 is a liquid crystal display device, and is a screen when the display device 24 is a projector.

The router 25 is connected to the router 34 of the head office system 3 via the network 4 in a communicative manner.

In the head office system 3, a head office client 31, the point of sales (POS) server 32, the content server 33, and the router 34 are connected to each other via a local network 35 in a communicative manner.

The head office client 31 is connected to the input device such as a mouse and a keyboard, and the display device. The head office client 31 is, for example, a computer.

The head office client 31 receives an operation input from an operator via the input device. The head office client 31 can remotely set a calculation formula used in the POS server 32 (for example, a calculation formula for calculating the sales amount) and a rule or an element related to this for the POS server 32 according to the operation input from this input device. In addition, the head office client 31 can remotely upload the content data to the content server, perform operations on the content data, and the like according to the operation input from this input device.

The POS server 32 receives the product data from the POS register 21, and transmits an adjustment instruction that enables a dynamic sales promotion in a customer-attracting situation to the content server 33.

When the content server 33 receives the adjustment instruction from the POS server 32, it distributes the content to the media player 23 via the router 25 and the network 4.

The content server 33 and the POS server 32 are, for example, computers.

The router 34 is connected to the router 25 of the store system 2 via the network 4 in a communicative manner.

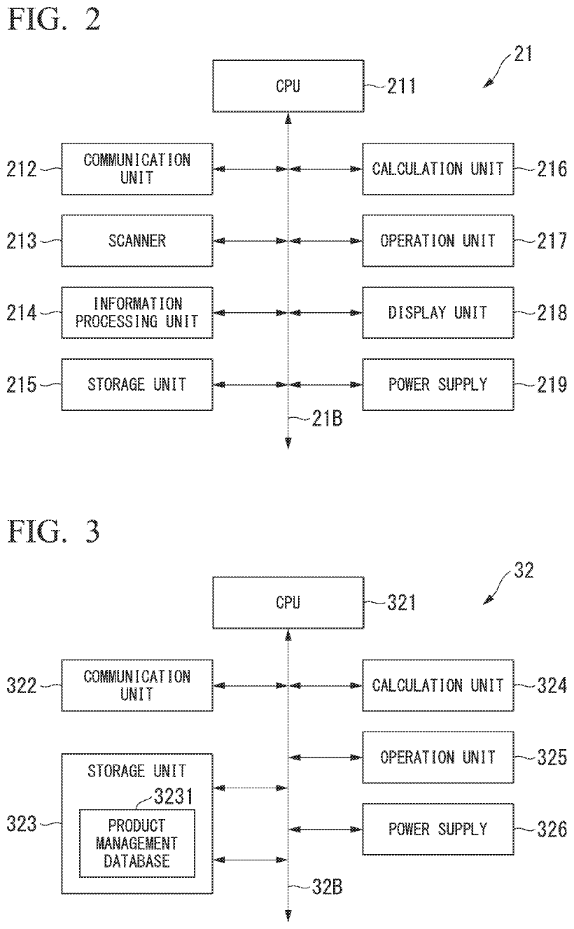

FIG. 2 is a functional block diagram that describes a function of the POS register 21.

The POS register 21 includes a CPU 211, a communication unit 212, a scanner 213, an information processing unit 214, a storage unit 215, a calculation unit 216, an operation unit 217, a display unit 218, a power supply 219, and a bus 21B.

A central processing unit (CPU) 211 transmits commands to each unit inside the POS register 21 via the bus 21B.

The communication unit 212 performs local area network (LAN) communication with each device inside the store system 2 via the local network 26.

The scanner 213 reads the product identification code. This scanner 213 may be the scanner 21a described above.

The information processing unit 214 adds a store code to the product identification code read by the scanner 213 (or the scanner 21a) to generate sales data, and transmits the generated sales data to the POS server 32 via the communication unit 212. A store code is identification information that identifies a store. The store code is assigned to a store in which the POS register 21 is installed. The store code may be stored in the storage unit 215.

In addition, the information processing unit 214 writes the sales data to the storage unit 215.

The storage unit 215 stores sales data, product data, inventory data, and store data, product data is data including product identification code and a selling price. Inventory data is data including product identification code and an inventory quantity in a store. Store data is data including a sales amount in a store.

The calculation unit 216 obtains the sales amount on the basis of the sales data and the product data, and updates the store data stored in the storage unit 215. The calculation unit 216 updates an inventory quantity of the inventory data stored in the storage unit 215 on the basis of the sales data.

The operation unit 217 is an input device such as a keyboard or a mouse, and receives an operation input from the user. The display unit 218 displays various types of data. The display unit 218 may be a liquid crystal panel. The power supply 219 supplies power to each unit of the POS register 21. The bus 21B is connected such that each unit inside the POS register 21 can communicate with each other. In addition, the bus 21B supplies power output from the power supply 219 to the inside of the POS register 21.

The communication unit 212, the information processing unit 214, and the calculation unit 216 have been described as functions separate from the CPU 211, but the CPU 211 may realize these functions by the CPU 211 executing a program for realizing at least one of these functions.

FIG. 3 is a functional block diagram which describes a function of the POS server 32.

The POS server 32 includes a CPU 321, a communication unit 322, a storage unit 323, a calculation unit 324, an operation unit 325, a power supply 326, and a bus 32B.

The CPU 321 transmits commands to each unit inside the POS server 32 via the bus 32B.

The communication unit 322 performs LAN communication with each device inside the head office system 3 via the local network 35.

The communication unit 322 receives sales data transmitted from a terminal of the store (for example, the POS register 21). The communication unit 322 receives sales data transmitted from each terminal of the plurality of stores when there are a plurality of stores and, accordingly, there are a plurality of store systems 2.

The storage unit 323 stores various types of data. The storage unit 323 includes product management database 3231.

The product management database 3231 stores product management data.

The calculation unit 324 updates the product management database 3231 on the basis of the sales data received from the POS register 21.

The calculation unit 324 can function as a first calculation unit for obtaining a sales amount, which is a sum of prices for first products sold, as target product, and an inventory quantity of the first product, on the basis of the sales data received by the communication unit 322.

When there are a plurality of stores, the calculation unit 324 obtains the sales amount by obtaining the sum of prices for the first products sold for each store on the basis of the sales data transmitted from a terminal of each of the plurality of stores, and obtains the inventory quantity by obtaining a sum of store-based inventory quantity for each store.

The calculation unit 324 can function as a determination unit that determines a magnitude relationship between at least one of the sales amount and the inventory quantity and a reference value. The reference value may be stored in the storage unit 323 in advance. The reference value may be changeable according to the operation input from the operation unit 325. In addition, the reference value may receive operation content input from the input device of the head office client 31 via the local network 35 and may be changed on the basis of this operation content. The reference value includes a sales reference value representing a reference of the sales amount and an inventory reference value representing a reference of the inventory quantity. Such reference values may be input in advance before the content is displayed. Moreover, the reference value may be changed while the content is being displayed after the content has started to be displayed. When it is changed while the content is being displayed, it can be adjusted according to a visitor situation of the day or a sales situation in which discount products are sold faster than expected.

The calculation unit 324 can function as a control unit that determines a display level for displaying contents related to the first products and contents related to second products, which are products different from the first products, in a display region according to a result of the determination.

The calculation unit 324 can function as a second calculation unit that outputs instructions to display the contents related to the first products and the contents related to the second products in the display region according to the display level determined by the calculation unit 324.

Here, it can be said that the display level is a size (power of appeal) at which content displayed on the display device can appeal to viewers. For example, the power of appeal may sometimes be called to as “impression” in advertising industry.

The display level can be determined according to a display time for displaying content. For example, when content is displayed in one display period, distribution for displaying the contents related to the first products and the contents related to the second products can be determined according to the display level.

When the contents are product advertisement, the display level can be increased by increasing a time for displaying the advertisement, and the display level can be decreased by decreasing the time for displaying the advertisement. Here, as the time for displaying the advertisement is increased, the viewers can get more opportunities to view it, which can lead to an increase in power of appeal. When the time for displaying the advertisement is decreased, the viewers get less opportunities to view it, which can cause the power of appeal to be curbed.

The calculation unit 324 calculates a first display for displaying the contents related to the first products according to a result of determining the magnitude relationship, and determines a length of display time for displaying the contents related to the first products and the contents related to the second products in the display region. For example, when the calculation unit 324 curbs power of appeal of the contents related to the first products and enhances power of appeal of the contents related to the second products, a display level of the contents related to the first products is lowered to below a display level of the contents related to the first products that has been displayed so far.

At this time, a ratio in length of the display time of the contents related to the first products to the display time of the contents related to the second products may be changed in the display period. For example, the display time of the contents related to the second products can be increased by decreasing the ratio of the display time of the contents related to the first products.

In addition, the display level can be determined according to an area of a display region for displaying the advertisement.

For example, when content is displayed in at least one display region, a distribution of an area of a region in which the contents related to the first products is displayed and an area of a region in which the contents related to the second products is displayed can be determined according to the display level.

When the contents are product advertisement, the display level can be increased by increasing in size an area for displaying the advertisement, and the display level can be decreased by decreasing the area for displaying the advertisement. Here, as the area for displaying the advertisement is increased in size, the advertisement is more likely to be visually recognized by the viewers, which can lead to an increase in power of appeal. As the area for displaying the advertisement is decreased in size, the advertisement is less likely to be visually recognized by the viewers, which can cause the power of appeal to be curbed.

The calculation unit 324 determines a ratio between a first area for displaying the contents related to the first products and a second area for displaying the second products that are different from the first products in an area for displaying content in the display region according to the result of determining the magnitude relationship, and displays the content in the display region. For example, when the calculation unit 324 curbs the power of appeal of the contents related to the first products and enhances the power of appeal of the contents related to the second products, the display level of the contents related to the first products is lowered to below the display level of the contents related to the first products that has been displayed so far by further decreasing the display area thereof.

At this time, in the display region, the ratio of the display area of the contents related to the first products to the display area of the contents related to the second products may be changed. For example, by decreasing the ratio of the contents related to the first products, the display area of the contents related to the second products can be increased.

Here, the first products can be discount products with an amount of money set cheaper than a standard price, and the second products can be products with a degree of discount lower than the first products. The standard price may be a list price. The second products may be, for example, products whose prices are listed prices (hereinafter referred to as listed price product). In stores, campaigns, sales, and the like may be performed. In this case, discount products are often prepared. As the first products, discount product that are handled in such campaigns or sales can be selected, and products that are not subject to discount in campaigns or sales can be selected as the second products. The products may be any products whose inventory quantity can be managed, such as clothes, accessories, daily necessities, home appliances, and the like.

When the content is displayed with a display level of the first products set higher than a display level of the second products, it is possible to enhance the power of appeal of contents related to discount products and to curb the power of appeal of contents related to listed price products. A discount product may be prepared for a purpose of attracting customers in some cases, and it is possible to increase a likelihood that list price products will be purchased depending on a customer-attracting situation by changing the display level of the power of appeal of the contents related to this discount products according to a sales amount of the discount products or a remaining inventory quantity of the discount products. As a result, products purchased by purchasers are not concentrated on the discount products in a store, but while the discount products are used as a trigger to attract customers, there are more opportunities for them to purchase listed price products. As a result, while the discount products is used as a trigger to attract customers, the store can get them to purchase products with high profit margins, which makes it possible to increase the sales amount.

The operation unit 325 is an input device such as a keyboard or a mouse, and receives an operation input from the user. The power supply 326 supplies power to each unit of the POS server 32. The bus 32B is connected such that each unit inside the POS server 32 can communicate with each other. In addition, the bus 32B supplies power output from the power supply 326 to the inside of the POS server 32.

The communication unit 322 and the calculation unit 324 have been described as functions separate from the CPU 321, but the CPU 321 may realize these functions by the CPU 3211 executing a program for realizing at least one of these functions.

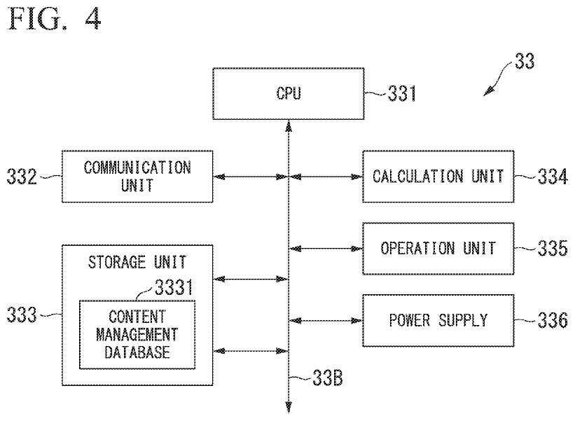

FIG. 4 is a functional block diagram which describes a function of the content server 33.

The content server 33 includes a CPU 331, a communication unit 332, a storage unit 333, a calculation unit 334, an operation unit 335, a power supply 336, and a bus 33B.

The CPU 321 transmits commands to each unit inside the content server 33 via the bus 32B. The communication unit 332 performs LAN communication with each device inside the head office system 3 via the local network 35. The storage unit 333 stores various types of data. The storage unit 333 includes a content management database 3331. The content management database 3331 stores content data. The content data includes products advertisement.

The calculation unit 334 analyzes the adjustment instruction received from the POS server 32 and adjusts at least one of a display time and a display region of the content data according to a result of the analysis.

The operation unit 335 is an input device such as a keyboard or a mouse, and receives an operation input from the user.

The power supply 336 supplies power to each unit of the content server 33.

The bus 33B is connected so that each unit inside the content server 33 can communicate with each other. In addition, the bus 33B supplies power output from the power supply 336 to the inside of the content server 33.

The communication unit 332 and the calculation unit 334 have been described as functions separate from the CPU 331, but the CPU 331 may realize these functions by the CPU 3311 executing a program for realizing at least one of these functions.

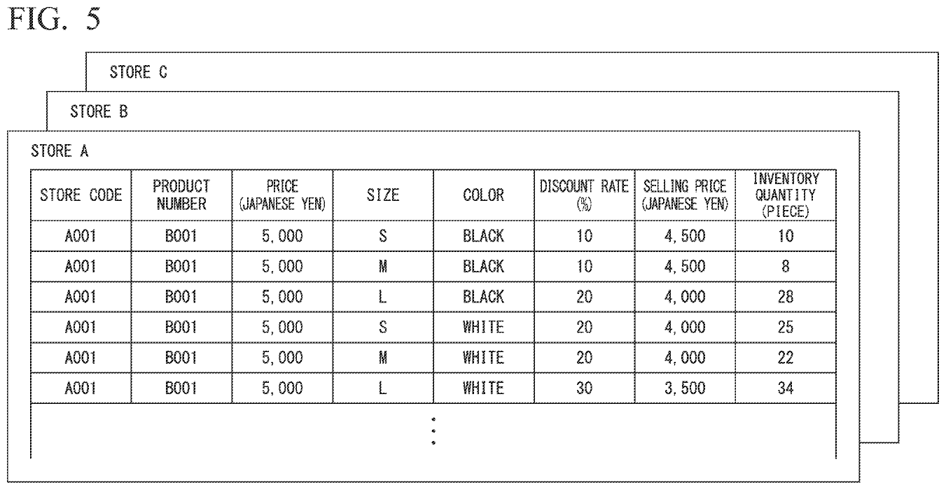

FIG. 5 is a diagram which shows an example of product management data stored in the product management database 3231 of the POS server 32.

Product management data includes a store code, product number, a list price, a size, a color, a discount rate, a selling price, and an inventory quantity.

A store code is identification information that identifies a store. Products number is identification information that identifies products. Product identification code may be used for the product number. A list price represents a list price of the product. A size represents a size set for 0 product. A color represents a color set for 0 product. A discount rate represents a discount rate set for product. A selling price indicates an amount of money obtained by discounting the list price according to the discount rate. An inventory quantity represents an amount of inventory of products.

An amount of inventory can be represented by number, weight, and the like depending on products. Here, when there is no development of products of different colors and there is no development of different sizes in one product, products number may be used as product identification code. When there is a development of products of different colors and there is a development of different sizes in one product, data that enables identification of a combination of products number, a color, and a size may be used as the product identification code. Even if there is one product, the discount rate may differ depending on the size and color. In other words, even if the product number is the same, the discount rate may differ depending on the size and color.

The product management database 3231 stores product management data for each store. For example, if there are three stores, store A, store B, and store C, the product management data can also be stored separately based on a store code.

The storage unit 215, the storage unit 323, and the storage unit 333 described above are configured from storage media such as a hard disk drive (HDD), a flash memory, an electrically erasable programmable read only memory (EEPROM), a random access read (RAM), and a read only memory (ROM) or any combination of these storage media. The storage unit 215, the storage unit 323, and the storage unit 333 can use, for example, a non-volatile memory.

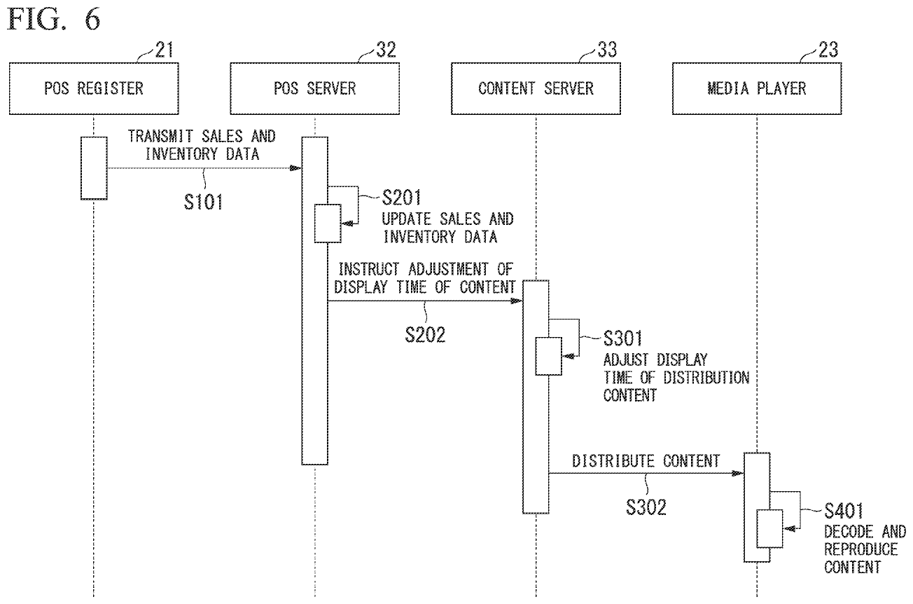

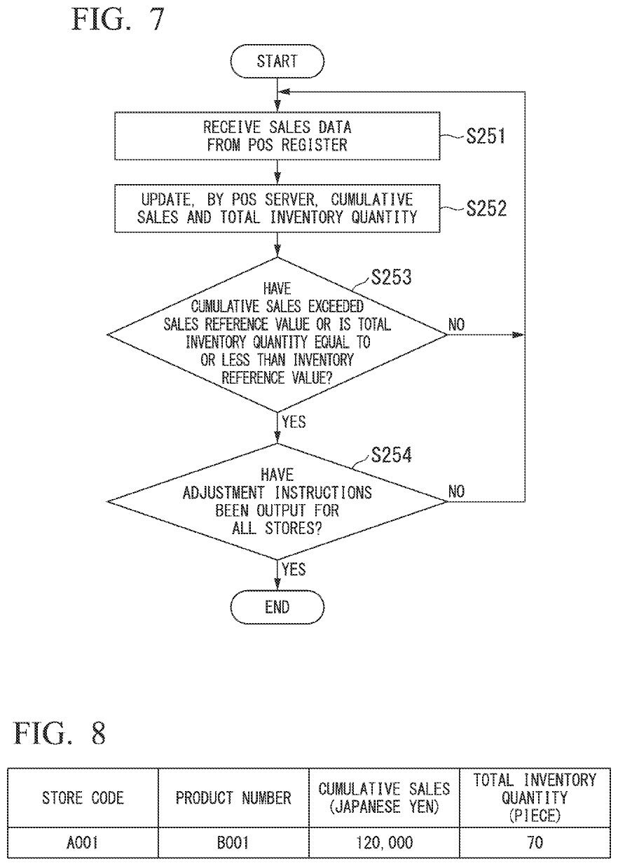

FIG. 6 is a sequence diagram which describes an operation of the display system 1, and FIG. 7 is a flowchart which describes an operation of the POS server 32.

When a consumer purchases products in a store, the scanner 213 of the POS register 21 installed in the store having products to be purchased reads the product identification code from the product tag attached to the product to be purchased. The information processing unit 214 attaches a store code assigned to a host store to the product identification code read by the scanner 213 to generate sales data, and transmits the generated sales data to the POS server 32 (step S101 in FIG. 6). Here, the information processing unit 214 may transmit the sales data to the POS server 32 each time the product tag is read, or store the sales data generated for a certain period of time and transmit it to the POS server 32 when a transmission timing is reached.

When the sales data is transmitted, the information processing unit 214 can also obtain an inventory quantity after the product is sold this time, and transmit the inventory quantity to the POS server 32 as the inventory data.

When the sales data and the inventory data are transmitted from the POS register 21, the POS server 32 receives the transmitted sales data and inventory data (step S251 in FIG. 7). The calculation unit 324 of the POS server 32 obtains a sales amount on the basis of the received sales data and product data stored in the storage unit 215. The calculation unit 324 extracts product identification code included in the sales data, reads a selling price corresponding to the extracted product identification code, and obtains a cumulative value of the read selling prices to obtain a cumulative sales amount. The calculation unit 324 may obtain the sales amount on the basis of a sales from an opening time of the store, or may obtain the sales amount of sold products from a time when target products are displayed on a display shelf after the store opens. When the calculation unit 324 obtains the sales amount, the calculation unit 324 also obtains the inventory quantity for store data corresponding to a store code on the basis of the product identification code and the store code included in the sales data.

When the calculation unit 324 obtains the sales amount and obtains the inventory quantity, it updates aggregate data. Here, FIG. 8 is a diagram which shows an example of aggregate data. Aggregate data is data that include a store code, products number, cumulative sales, and a total inventory quantity. Store aggregate data is stored in the storage unit 215.

The calculation unit 324 updates the store aggregate data by writing the obtained sales amount as a cumulative sales value and writing the obtained inventory quantity as a total inventory quantity value (step S201 in FIG. 6, step S252 in FIG. 7).

Here, if the product numbers of products are the same, the calculation unit 324 sums up the sales amounts to obtain the cumulative sales amount even if the discount rates (selling prices) are different due to differences in specifications such as color and size. As a result, the calculation unit 324 can integrate the products with different discount rates and treat them as one and similar in type even if the specifications (color, size, and the like) are different. In addition, if the product numbers are the same, the calculation unit 324 sums up the inventory quantity for each specification such as color and size to obtain a total inventory quantity. As a result, even if the specifications such as color and size are different, it is possible to obtain the total number of remaining products for the purpose of attracting customers.

Here, a case in which the calculation unit 324 obtains cumulative sales, which is a sum of selling prices of products with the same product code, and a total inventory quantity, which is a sum of inventory quantities will be described, but store aggregate data may be derived individually for each color or size.

If the store aggregate data is updated, the calculation unit 324 determines the magnitude relationship between the cumulative sales and total inventory quantity and the reference values (step S253 in FIG. 7). The calculation unit 324 may perform this determination each time the store aggregate data is updated, or may perform the determination when a determination timing is reached. Determination timing may be every certain period of time (for example, every 10 minutes, every 30 minutes, or the like), or every time a certain number of products are sold (for example, every 5 pieces, every 10 pieces, or the like).

When the magnitude relationship is determined, the calculation unit 324 determines whether the cumulative sales have exceeded the sales reference value.

For example, the calculation unit 324 determines the magnitude relationship between the total inventory quantity and the inventory reference value. Here, calculation unit 324 determines whether the total inventory quantity is equal to or less than the inventory reference value.

When the cumulative sales have exceeded the sales reference value, or when the total inventory quantity is equal to or less than the inventory reference value, the calculation unit 324 advances the processing to step S254 in FIG. 7 (YES in step S253 in FIG. 7). When the cumulative sales do not exceed the sales reference value and the total inventory quantity exceeds the inventory reference value, the calculation unit 324 advances the processing to step S251 in FIG. 7 and waits to receive the sales data from the POS register 21. (No in step S253 in FIG. 7).

When the cumulative sales have exceeded the sales reference value or when the total inventory quantity is equal to or less than the inventory reference value, it is possible to quickly grasp that a goal of attracting customers has been achieved on the basis of any one of the sales amount and the inventory quantity.

In addition, here, the calculation unit 324 may advance the processing to step S254 in FIG. 7 when the cumulative sales exceed the sales reference value and the total inventory quantity is equal to or less than the inventory reference value. When the cumulative sales exceed the sales reference value and the total inventory quantity is equal to or less than the inventory reference value, it can be understood that a degree of customer attraction is sufficient.

Alternatively, the calculation unit 324 may advance the processing to step S251 in FIG. 7 when the cumulative sales do not exceed the sales reference value or if the total inventory quantity exceeds the inventory reference value.

When a result of the determination in step S253 in FIG. 7 is YES, the calculation unit 324 transmits an adjustment instruction, which is instructions to adjust a display time of an advertisement, to the content server 33 via the communication unit 322 (step S202 in FIG. 6, step S254 in FIG. 7).

Here, when the result of the determination in step S253 of FIG. 7 is YES, since the sales amount of sale items has reached a certain price, or the inventory quantity of sale items is below a certain amount, it can be said that sale items have been purchased to a certain extent in the store. For this reason, it can be said that the goal of attracting customers has reached a certain level.

The adjustment instruction may be, for example, a control command. When the adjustment instruction is a control command, the control command can be substituted with a numerical value representing the ratio of the display times or the ratio of the areas of a display region. The calculation unit can directly indicate a numerical value by transmitting this control command to the content server 33.

For example, when the control command is an adjustment instruction that adjusts the display time, it is possible to specify a time for displaying content in seconds. For example, the display time for an advertisement for sale items can be set to 5 seconds, and the display time for an advertisement for products whose price is list price can be set to 5 seconds. In addition, the adjustment instruction may be a value that specifies the display time, or instructions that specifies the display time, and may also be instructions to specify the ratio of the display time for an advertisement for sale items to the display time of an advertisement for other products in one display period (for example, 5:5, or the like).

For example, when the control command is an adjustment instruction to adjust the area of a display region, the numerical value representing the ratio of the areas can be specified. For example, the ratio can be specified such that the area of the advertisement for the sale item is 7 and the display area of the advertisement for the list price product is 3.

The calculation unit 324 determines whether adjustment instructions have been output for all stores (step S254 in FIG. 7). The calculation unit 324 ends the processing when adjustment instructions have been output for all stores (YES in step S254 in FIG. 7), and when there are stores for which adjustment instructions have not been output (NO in step S254 in FIG. 7), the processing proceeds to step S251 in FIG. 7.

The calculation unit 324 may use the same sales reference value and inventory reference value for the sales reference value and the inventory reference value in other stores to be managed. As a result, it is not necessary to set the sales reference value and inventory reference value individually for each store, so time and effort for setting the values can be reduced.

The communication unit 332 of the content server 33 receives an advertisement adjustment instruction from the POS server 32. The calculation unit 334 adjusts the display time of the content or the area of a display region according to the numerical value representing the ratio included in the received adjustment instruction (step S301 in FIG. 6).

When the adjustment instruction is an adjustment instruction that adjusts the display time, the calculation unit 334 changes the display time of the content according to this adjustment instruction.

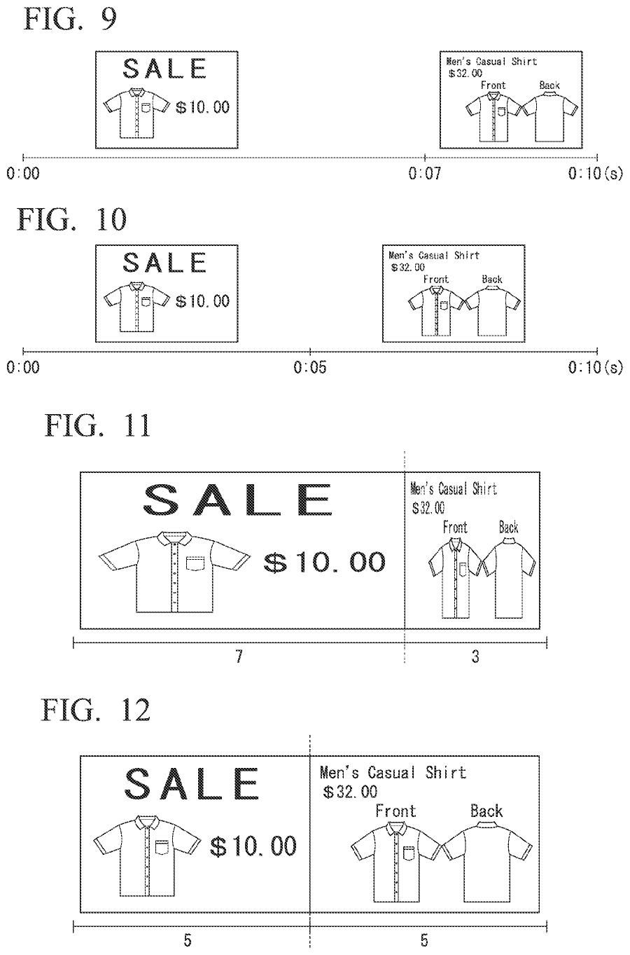

FIG. 9 is a diagram which describes a case in which the content is displayed on the display device 24 according to the display time. Here, one display period is 10 seconds, of which the display time of the first products (a sale item) is 7 seconds and the display time of the second products (listed price products) is 3 seconds. In this case, after the content of the advertisement related to the sale item is displayed on the display device 24 for 7 seconds, the contents of the advertisement related to the list price products is displayed on the display device 24 for 3 seconds. After that, the contents of the advertisement related to the sale item is displayed again. Before the adjustment instruction is received, the advertisement related to the sale item is made longer than the advertisement related to the listed price product in one display period in this manner.

FIG. 10 is a diagram which describes the case in which content is displayed on the display device 24 according to the display time. Here, a case is represented in which the content server 33 has received an adjustment instruction and adjusted a display of the content according to an adjustment instruction.

Here, a case is represented in which one display period is 10 seconds, of which the display time for the content of the advertisement for the sale item is 5 seconds, and the display time for the content of the advertisement for the list price products is 5 seconds.

When the adjustment instruction includes instructions to set the display time of the advertisement for the sale item to 5 seconds and the display time of the advertisement for other products to 5 seconds, the calculation unit 334 generates content in which the advertisement for the sale item is displayed for 5 seconds and the advertisement for other products is displayed for 5 seconds according to this instruction.

When the adjustment of the display time is finished, the calculation unit 334 distributes the adjusted content to the media player 23 of the store via the communication unit 332 (step S302 in FIG. 6).

When the media player 23 of the store receives the content from the content server 33, it decodes the received content and reproduces it (step S401 in FIG. 6). As a result, the display device 24 connected to the media player 23 displays the content in which the advertisement for the sale item is displayed for 7 seconds and the advertisement for the list price products is displayed for 3 seconds, but, in response to new content being supplied from the media player 23, displays content in which the advertisement for the sale item is displayed for 5 seconds and the advertisement for the list price products is displayed for 3 seconds. Here, when the content includes not only a video signal but also an audio signal, the display device 24 outputs the audio signal from a speaker.

If the adjustment instruction is an adjustment instruction that adjusts the display area, the calculation unit 334 changes the area for displaying the content according to this adjustment instruction.

FIG. 11 is a diagram which describes a case in which content is displayed on the display device 24 according to a display area. Here, a case is represented in which the content is displayed according to a ratio in which the area for displaying the advertisement for the sale item is 7 and the area for displaying the advertisement for the list price products is 3 in one display region, which is a region of a display screen of the display device 24. Before the adjustment instruction is received, the advertisement for the sale item is displayed in a wider region than the content of the advertisement for the list price products in one display region in this manner.

FIG. 12 is a diagram which describes a case in which content is displayed on the display device 24 according to a display area. Here, a case is represented in which the content server 33 receives an adjustment instruction from the POS server 32 and adjusts a display of the content according to the adjustment instruction.

Here, a case is represented in which the content is displayed according to a ratio in which the area for displaying the advertisement for the sale item is 5 and the area for displaying the advertisement for the list price products is 5 in one display region, which is the region of the display screen of the display device 24.

When the adjustment instruction includes instructions to set the display area of the advertisement for the sale item to 5 and the display area of the advertisement for the other products to 5, the calculation unit 334 of the content server 33 generates content set with a ratio of the areas in which the display area of the advertisement for the sale item is set to 5, and the display area of the advertisement for the list price products is set to 5 according to this instruction.

When the adjustment of the display area is finished, the calculation unit 334 distributes the adjusted content to the media player 23 of the store via the communication unit 332 (step S302 in FIG. 6).

When the media player 23 of the store receives the content from the content server 33, it decodes and reproduces the received content (step S401 in FIG. 6). The media player 23 supplies a video signal generated by reproducing the content to the display device 24. The display device 24 displays the content in which the display area of the advertisement for the sale item is 7 and the display area of the advertisement for the list price products is 3 in one display region, but, in response to new content being supplied from the media player 23, displays the content in which the display area of the advertisement for the sale item is 5 and the display area of the advertisement for the list price products is 3. Here, when the content includes not only a video signal but also an audio signal, the display device 24 outputs the audio signal from the speaker.

Here, the store may have a plurality of display devices 24 instead of one display device. For example, there are cases in which the plurality of display devices are installed at an entrance of a store, or the plurality of display devices are installed at intervals on walls, display shelves, and the like in a store. Even if the plurality of display devices 24 are provided in this manner, content can be displayed on each display device 24 as described above.

For example, when the content is displayed on the display device 24 according to a display time, the content server 33 generates content according to an adjustment instruction and transmits the generated content to each of the plurality of display devices 24. As a result, for example, each display device 24 displays the content in which the advertisement for the sale item is displayed for 7 seconds and the advertisement for the list price products is displayed for 3 seconds, but, in response to new content being supplied from the media player 23, displays content in which the advertisement for the sale item is displayed for 5 seconds and the advertisement for the list price products is displayed for 3 seconds.

In addition, for example, when the content is displayed on the display device 24 according to a display area, the content server 33 generates content according to the adjustment instruction and transmits the generated content to each of the plurality of display devices 24.

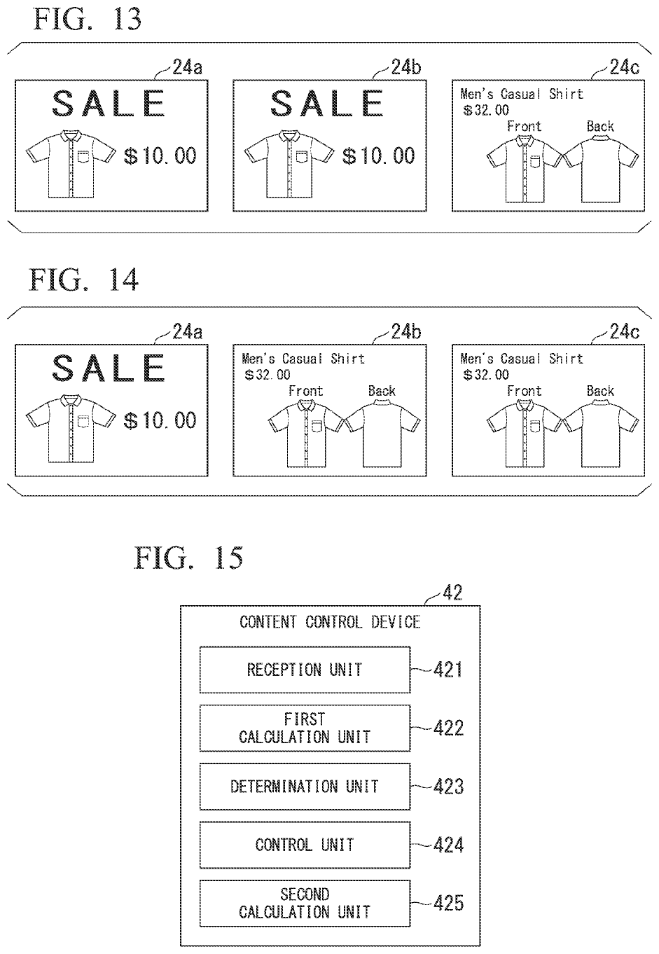

Here, when there are a plurality of display regions, the calculation unit 324 of the POS server 32 determines a display region to be displayed among the plurality of display regions such that a sum of areas of the display regions that display the first products is a first area. According to a more specific example, as shown in FIG. 13, three display devices 24 such as a display device 24a, a display device 24b, and a display device 24c may be installed on walls near the entrance of the store. In this case, before the adjustment instruction is transmitted to the content server 33, a display instruction is transmitted from the content server 33 to the media player 23 to perform a display at a ratio in which the display area of the advertisement for the sale item is 2 and the display area of the advertisement for other products is 1. In response to this display instruction being received, the media player 23 transmits the advertisement for the sale item to the display devices 24a and 24b, and transmits the advertisement for the list price products to the other display device 24c. As a result, before the adjustment instruction is transmitted to the content server 33, as shown in FIG. 13, the advertisement for the sale item is displayed in a display region of each of the display devices 24a and 24b, and the advertisement for the list price products is displayed in a display region of the display device 24c. In this display state, the area for displaying the advertisement for the sale item is larger than the area for displaying the advertisement for the list price products.

Next, the content server 33 transmits a display instruction to the media player 23 to display at a ratio in which the display area of the advertisement for the sale item is 1 and the display area of the advertisement for other products is 2. In response to this display instruction being received, the media player 23 transmits the advertisement for the sale item to the display device 24a, and the advertisement for the list price products to the display devices 24b and 24c. As a result, after the adjustment instruction is transmitted to the content server 33, as shown in FIG. 14, the advertisement for the sale item is displayed in the display region of the display device 24a, and the advertisement for the list price products is displayed in the display regions of the display devices 24b and the display device 24c. In this display state, the area for displaying the advertisement for the sale item is smaller than the area for displaying the advertisement for the list price products.

Next, another embodiment of the POS server 32 will be described.

FIG. 15 is a schematic block diagram which describes a configuration of a content control device 42, which is another embodiment of the POS server 32.

The reception unit 421 receives sales data transmitted from the terminal of the store. The first calculation unit 422 obtains a sales amount, which is a sum of prices for first products sold, as target products, and an inventory quantity of the first products on the basis of the sales data received by the reception unit 421. The determination unit 423 determines the magnitude relationship between at least one of the sales amount and inventory quantity and the reference value. The control unit 424 determines a display level for displaying contents related to the first products and contents related to second products, which is products different from the first products, in a display region according to a result of the determination. The second calculation unit 425 outputs instructions to display the contents related to the first products and the contents related to the second products in the display region according to the display level determined by the control unit 424.

In the embodiment described above, a case in which the adjustment instruction is transmitted once in one store has been described, but the display level may be changed step by step by using a plurality of sales reference values and inventory reference values. For example, when the display time is adjusted, content in which the display time of the advertisement for the sale item is set to 7 seconds and the display time of the advertisement for products whose price is a list price is set to 3 seconds is displayed. The calculation unit 324 uses a sales reference value and an inventory reference value in a first stage to determine the magnitude relationship, and outputs an adjustment instruction according to a result of the determination. As a result, the calculation unit 324 causes the display device 24 to display content in which the display time of the advertisement for the sale item is set to 5 seconds, and the display time of the advertisement for the products whose price is a list price is set to 5 seconds. Next, the calculation unit 324 uses the sales reference value and the inventory reference value in a second stage to determine the magnitude relationship, and outputs an adjustment instruction according to a result of the determination. Here, a sales reference value with a higher amount than the sales reference value in the first stage is used as a sales reference value in the second stage, and an inventory reference value with a smaller number than the inventory reference value in the first stage is used as the inventory reference value in the second stage. In this case, the calculation unit 324 causes the display device 24 to display content in which, for example, the display time of the advertisement for the sale item is set to 3 seconds and the display time of the advertisement for the products whose price is a list price is set to 7 seconds. This allows the display level of the content of discount products to be lowered step by step.

In addition, in the embodiment described above, a case in which cumulative sales are obtained for discount products has been described, but products other than discount products (for example, list price products) may also be targets for obtaining cumulative sales. In this case, a value obtained by assuming a sum amount of the discount products and the list price products may be used for the sales reference value. In this case, the display level of the discount products can be changed after the sales of a plurality of products are considered.

Moreover, in the embodiment described above, the inventory reference value may be the inventory quantity, but it may also be a ratio that allows an understanding of how much an inventory of the discount products has decreased. For the ratio, for example, a value obtained by dividing the inventory quantity at the time of starting management of the inventory quantity of the discount products (for example, the inventory quantity at the time of opening the store) by the number of sales of the discount products can be used.

According to the embodiment described above, it is possible to more effectively attract customers using product advertisement than in the past. In other words, when it is expected that purchases will concentrate only on products to be posted in the advertisement, the amount of advertisement and promotion for other products is increased from time to time and purchases by consumers are distributed to a plurality of products, and thereby it is possible to promote a simultaneous purchase with normal products and to prevent the products posted in the advertisement from running out of inventory early. Therefore, it is possible to improve the total sales of the store because an average sales per customer can be increased and a means of attracting customers can be maintained for a long period of time.

In addition, a construction management may be performed by recording a program for realizing the functions of the POS server 32 in FIG. 1 in a computer-readable recording medium, and causing a computer system to read a program recorded in this recording medium and to execute it. The term “computer system” used herein includes an OS and hardware such as peripheral devices.

In addition, the “computer system” includes a homepage provision environment (or a display environment) when a WWW system is used.

In addition, the “computer-readable recording medium” refers to a portable medium such as a flexible disk, a magneto-optical disc, a ROM, or a CD-ROM, or a storage device such as a hard disk embedded in the computer system. Furthermore, it is assumed that the “computer-readable recording medium” includes a medium that hold a program for a certain period of time, such as a volatile memory inside a computer system serving as a server or a client. Moreover, the program described above may be a program for realizing a part of the functions described above, or may be furthermore a program capable of realizing the functions described above in combination with a program already recorded in the computer system. In addition, the program described above may be stored in a predetermined server, and distributed (downloaded, or the like) via a communication line in response to a request from another device.

Although the embodiment of the present invention has been described in detail with reference to the drawings, a specific configuration is not limited to this embodiment, and includes a design within a range not departing from the gist of the present invention.

### REFERENCE SIGNS LIST

1 Display system

2 Store system

3 Head office system

4 Network

21 POS register

21a, 213 Scanner

21B, 32B, 33B Bus

22 Store client

23 Media player

24, 24a, 24b, 24c Display device

25, 34 Router

26, 35 Local network

31 Head office client

32 POS server

33 Content server

42 Content control device

212, 322, 332 Communication unit

214 Information processing unit

215, 323, 333 Storage unit

216, 324, 334 Calculation unit

217, 325, 335 Operation unit

218 Display unit

219, 326, 336 Power supply

421 Reception unit

422 First calculation unit

423 Determination unit

424 Control unit

425 Second calculation unit

3231 Product management database

3331 Content management database

What is claimed is:

1. A content control device comprising:
a reception unit configured to receive sales data transmitted from a terminal of a store;
a first calculation unit configured to obtain a sales amount, which is a sum of prices for first products sold as target products, on the basis of the sales data received, and configured to obtain an inventory quantity of the first products;
a determination unit configured to determine a magnitude relationship between at least one of the sales amount and the inventory quantity and a reference value;
a control unit configured to determine display levels for displaying first contents related to the first products and for displaying second contents related to second products that are different from the first products, in a display region, in accordance with a result of the determination; and
a second calculation unit configured to output instructions to display the first contents related to the first products and the second contents related to the second products in the display region, in accordance with the display levels determined by the control unit.

2. The content control device according to claim 1,
wherein the reception unit is configured to receive sales data transmitted from a respective terminal of each of a plurality of stores, and
the first calculation unit is configured to obtain the sales amount by calculating a respective sum of prices for the first products sold for each store on the basis of the respective sales data transmitted from each of the plurality of stores, and configured to obtain the inventory quantity by obtaining a respective sum of store-based inventory quantity for each store.

3. The content control device according to claim 1,
wherein the first calculation unit is configured to obtain the sales amount and the inventory quantity including products that are similar in type to each other but are different in specifications.

4. The content control device according to claim 1,
wherein the control unit is configured to calculate a ratio between a first display time for displaying the first contents related to the first products and a second display time for displaying the second contents related to the second products that are different from the first products according to a result of the determination, and is configured to determine, based on the ratio, a first time to display the first contents related to the first products and a second time to display the second contents related to the second products in the display region.

5. The content control device according to claim 1,
wherein the control unit is configured to determine, in accordance with a result of the determination, a ratio between a first area for displaying the first contents related to the first products and a second area for displaying the second contents related to the second products that are different from the first products, and configured to display the contents in the display region.

6. The content control device according to claim 5,
wherein, if a plurality of display regions are available, the control unit is configured to determine, among the plurality of display regions, which display region or display regions are available for displaying the first contents related to the first products such that a sum of areas of the display regions determined to display the first contents related to the first products is equal to the first area.

7. The content control device according to claim 6,
wherein the first products are discount products with a price lower than a standard price, and
the second products are products with a degree of discount which is lower in degree than the discount of the first products.

8. The content control device according to claim 1,
wherein the display level is determined according to a length of display time for displaying contents and the display level indicates a power of appeal at which content displayed on the display device appeals to viewers.

9. The content control device according to claim 8,
wherein the second calculation unit is configured to determine a first length of time for displaying the first contents related to the first products and a second length of time for displaying the second contents related to the second products in the display region, according to the magnitude relationship determined by the determination unit.

10. The content control device according to claim 8,
wherein the second calculation unit is configured to determine a ratio in length of a first display time for displaying the first contents related to the first products and a second display time for displaying the second contents related to the second products in the display region, according to the magnitude relationship determined by the determination unit.

11. The content control device according to claim 1,
wherein the display level is determined according to an area of a display region for displaying contents and the display level indicates a power of appeal at which content displayed on the display device appeals to viewers.

12. The content control device according to claim 10,
wherein the second calculation unit is configured to determine a first area of a first display region for displaying the first contents related to the first products and a second area of a second display region for displaying the second contents related to the second products in the display region, according to the magnitude relationship determined by the determination unit.

13. The content control device according to claim 10,
wherein the second calculation unit is configured to determine a ratio in area of a first display region for displaying the first contents related to the first products and a second display region for displaying the second contents related to the second products in the display region, according to the magnitude relationship determined by the determination unit.

14. A non-transitory computer readable storage medium that stores computer- executable instructions, when executed by one or more computers, to cause one or more computers to at least:
receive sales data transmitted from a terminal of a store;
obtain a sales amount, which is a sum of prices for first products sold as target products, on the basis of the sales data received, and configured to obtain an inventory quantity of the first products;
determine a magnitude relationship between at least one of the sales amount and the inventory quantity and a reference value;
determine display levels for displaying first contents related to the first products and for displaying second contents related to second products that are different from the first products, in a display region, in accordance with a result of the determination; and
output instructions to display the first contents related to the first products and the second contents related to the second products in the display region, in accordance with the display levels determined by the control unit.

15. A content control method that is executed by one or more computers, the method comprising:
receiving sales data transmitted from a terminal of a store;
obtaining a sales amount, which is a sum of prices for first products sold as target products, on the basis of the sales data received, and configured to obtain an inventory quantity of the first products;
determining a magnitude relationship between at least one of the sales amount and the inventory quantity and a reference value;
determining display levels for displaying first contents related to the first products and for displaying second contents related to second products that are different from the first products, in a display region, in accordance with a result of the determination; and
outputting instructions to display the first contents related to the first products and the second contents related to the second products in the display region, in accordance with the display levels determined by the control unit.
